(19) United States
(12) Patent Application Publication
(10) Pub. No.: US 2004/0037399 A1
(43) Pub. Date: Feb. 26, 2004

(54) System and method for transferring phone numbers during a voice call

(75) Inventor: Bollapragada V.J. Manohar, San Diego, CA (US)

Correspondence Address: Siemens Corporation, Attn: Elsa Keller, Legal Administrator, Intellectual Property Department, 186 Wood Avenue South, Iselin, NJ, 08830, US

(73) Assignee: Siemens Information and Communication Mobile, LLC

(21) Appl. No.: 10/225,268

(22) Filed: Aug. 21, 2002

(51) Int. Cl. H04M 1/64

(52) U.S. Cl. 379/88.03

(57) ABSTRACT

A telecommunications device according to an embodiment of the present invention includes a handset having a keypad, speaker, and microphone on a face. A memory stores an address book of phone numbers. A controller is adapted to transmit one or more of the phone numbers responsive to a voice command to a connected party. In one embodiment of the telecommunications device, the controller activates the voice command functionality responsive to a function key.

### BACKGROUND OF THE INVENTION

The present invention relates to telecommunications devices and, in particular, to a wireless telephone having improved usability.

Handsets for telephony devices, and particularly for wireless telephones, such as cordless telephones and cellular telephones, are becoming increasingly small, with added capabilities, such as address books and Web browsing. Such handsets typically are configured to have a keypad and one or more function keys, as well as a microphone and a speaker, on a front face of the handset's housing. While such miniaturization has advantages, such a configuration can be awkward when ease of use is a consideration. More particularly, when the handset is in the “speak” position, the keypad, being pressed against the user's face, is inaccessible.

For example, users are often asked by the other party or parties to a conversation to provide a third party's telephone number. To provide the number, if the user has the number stored in the handset's address book, the user must remove the phone from his ear, then use the keypad to browse the address book for it, jot the number down or remember it, return the phone to “speak” position and tell the other party. As can be appreciated, while the user is accessing the address book, it may be difficult or not possible for the user to communicate with the other party or parties.

### SUMMARY OF THE INVENTION

These and other drawbacks in the prior art are overcome in large part by a system and method according to the present invention.

A telecommunications method according to one embodiment of the present invention includes accessing an address book while a communication is ongoing; and transmitting the accessed telephone number as a voice signal on the speech channel used for the communication. A telecommunications method according to a particular embodiment of the present invention includes activating a voice index function via a function key; retrieving a phone number in an address book via a voice tag; extracting speech signals for each digit in the phone number; and transmitting the digits on the voice channel used for speech communication.

A telecommunications device according to an embodiment of the present invention includes a handset having a keypad, speaker, and microphone on a face. A memory stores an address book of phone numbers. A controller is adapted to transmit one or more of the phone numbers responsive to a voice command to a connected party. In one embodiment of the telecommunications device, the controller activates the voice command functionality responsive to a function key.

A telecommunications system according to an embodiment of the present invention includes a plurality of telephony devices, such as wireless telephony devices. The wireless telephony devices include a voice synthesizer for generating a telephone number from an address book. The digits of the telephone number are transmitted on the voice channel during a communication between telephony devices.

A better understanding of these and other specific embodiments of the invention is obtained when the following detailed description is considered in conjunction with the following drawings.

### BRIEF DESCRIPTION OF THE DRAWINGS

FIG. 1A-FIG. 1C are diagrams of telecommunications devices according to embodiments of the present invention;

FIG. 2 is a diagram of a telecommunications system according to an embodiment of the present invention;

FIG. 3 is a diagram of a telephony handset according to an embodiment of the present invention;

FIG. 4 is a flowchart illustrating operation of an embodiment of the present invention;

FIG. 5 is a flowchart illustrating operation of an embodiment of the present invention;

FIG. 6 is a flowchart illustrating operation of an embodiment of the present invention; and

FIG. 7 is a block diagram of a voice recognition unit according to an embodiment of the present invention.

### DETAILED DESCRIPTION OF EMBODIMENTS OF THE INVENTION

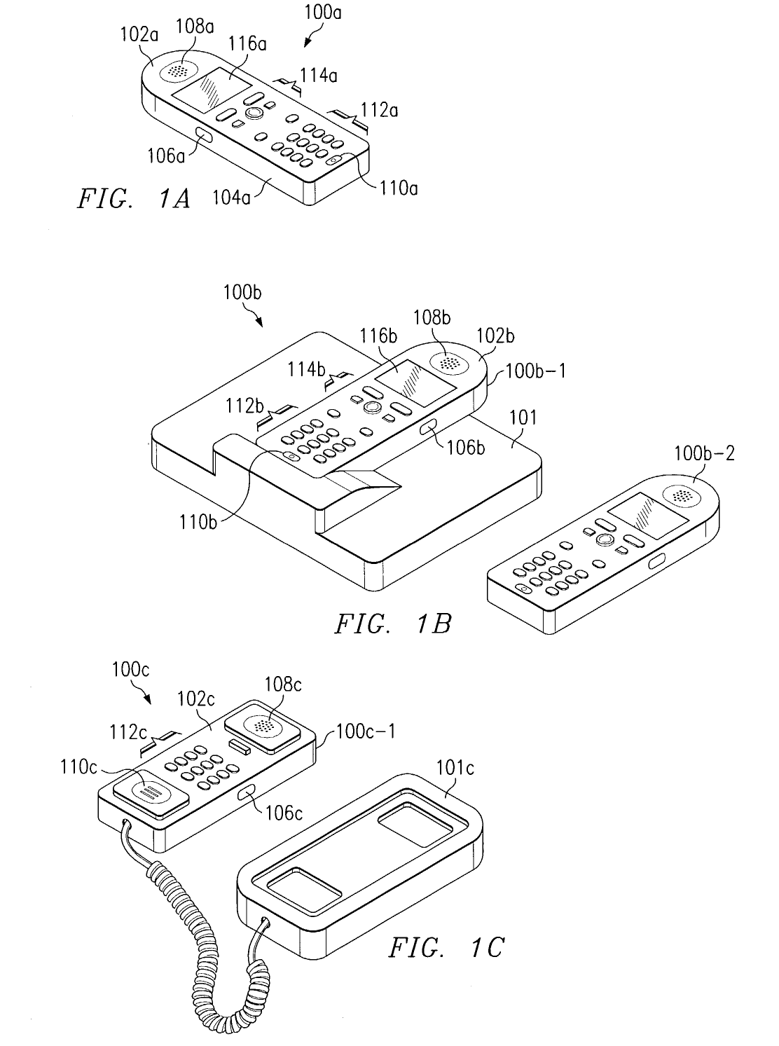

Turning now to the drawings and, with particular attention to FIGS. 1A-1C, there are shown telephony devices according to embodiments of the present invention.

More particularly, shown in FIG. 1A is a telephony handset 100a according to an embodiment of the present invention. The handset 100 is representative of, for example, a cellular telephone handset. As shown, the handset includes a housing 104a and a face 102a. As will be explained in greater detail below, a voice activation access control device 106a may be provided on the housing 104a and, in particular, may be positioned on a side of the housing different than face 102a. The voice activation access control 106a may be implemented, for example, as a switch or soft key.

In the embodiment illustrated, shown on the face 102a are a speaker 108a, microphone 110a, keypad 112a, one or more soft keys 114a, and display 116a. It is noted that additional configurations are known. Thus, the figures are exemplary only.

In operation, the keypad 112a and soft keys 114a are used to control calling and supplemental services, such as caller ID, call forwarding, address book calling, etc. The display 116a may be implemented as, for example, a liquid crystal display (LCD) and is used to display, e.g., telephone numbers, such as caller ID numbers, and address book telephone numbers. For example, the user may access the address book by pulling up on the display 116a a list of names and associated telephone numbers. The user may then scroll up and down the list, highlight a particular number, and call the highlighted party.

In addition, as will be explained in greater detail below, the address book may be accessed during a telephone conversation and a selected number may be transmitted on a voice channel. According to one embodiment of the present invention, while engaged in a telephone call, the user can press voice activation access control 106a without removing the handset from the “talk” position. The user can then access the address book by speaking a name or other voice index. The handset will then access the address book for the appropriate number and generate the digits, e.g., by vocalization or speech synthesis, for transmission to the requesting party over the speech channel.

FIG. 1B shows an alternate embodiment of a telecommunications device according to the present invention. In particular, the embodiment illustrated may be a cordless telephone. An exemplary cordless telephone is the Gigaset series, available from Siemens Corporation. The cordless telephone includes a base station 101 and a handset 100b-1. The handset 100b-1 is generally similar to the cellular telephone handset of FIG. 1A, and includes a keypad 112b, softkeys 114b, display 116b, microphone 110b, and speaker 108b on a face 102b. In addition, the handset 100b-1 may be provided with a voice activation access key 106b according to the present invention, as will be explained in greater detail below. Additional handsets 100b-2, may also be provided.

FIG. 1C illustrates another embodiment of a telephony device according to the present invention. In particular, FIG. 1C illustrates a landline telephone 100c, such as a conventional wireline digital phone or an IP phone, having a handset 100c-1 and a base 101c. As shown, the handset 100c-1 includes a keypad 112c, and a microphone 110c and speaker 108c on a face 102c. In addition, the handset 100c-1 may be provided with a voice activation access key 106c according to the present invention, as will be explained in greater detail below.

It is noted that, while particular configurations of telephony devices are illustrated in FIGS. 1A-1C, different configurations are possible. Thus, the figures are exemplary only.

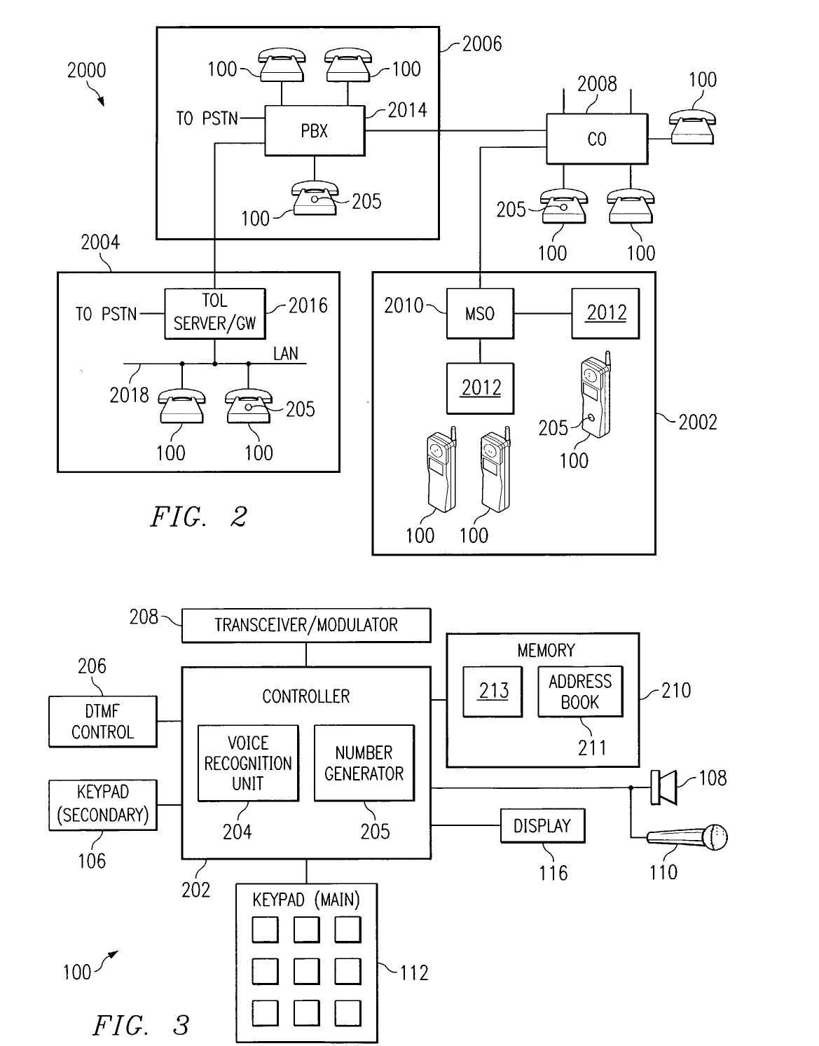

FIG. 2 illustrates various network configurations for a telecommunications system 2000 according to embodiments of the present invention. Shown in FIG. 2 are a plurality of telephony devices 100 associated with the telecommunications system. The telephony devices 100 may, for example, be implemented as the telephony devices 100a, 100b, 100c of FIGS. 1A-1C. As will be explained in greater detail below, one or more of the telephones 100 may include a number generator 205 according to the present invention. The number generator 205 functions to generate numbers corresponding to entries in an address book, for transmission on a speech channel from one user to another.

Shown are a cellular telephone network 2002, a telephony-over-LAN (ToL) network 2004, a PBX-based network 2006, and a Central Office (CO) based network 2008. It is noted, however, that other network configurations are possible, such as Internet telephony systems or other voice-over-I P systems. Further, while one each of a cellular telephone network, ToL network, PBX-based network, and CO-based network are shown, more or fewer of such networks may be present in the system. Thus, the figures are exemplary only.

The cellular telephone network 2002 includes a plurality of telephones according to embodiments of the present invention 100, one or more base stations 2012, and a metropolitan switching office 2010. The MSO 2012 may be coupled to a central office 2008. The cellular telephone network 2002 may be implemented as a GSM based system, for example.

Similarly, the telephony-over-LAN system 2004 may include a ToL server/gateway 2016 on a LAN 2018. The ToL system further includes one or more landline or wireless telephony devices 100 according to the present invention, as will be described in greater detail below. The ToL server/gateway 2016 may couple to a PBX 2014 and/or the public switched telephone network (PSTN). The ToL system 2004 may implement any of a variety of ToL systems, including the H.323 Recommendation or Session Initiation Protocol (SIP), for example. Further, the LAN may be either a landline LAN or a wireless LAN.

Network system 2006 may be a private telephone system based around a private branch exchange (PBX) 2014. Thus, a plurality of telephones 100 couple to the PBX 2014, which in turn couples to a central office 2008 and the public switched telephone network. Finally, a plurality of telephones 100, either landline or wireless, may couple to the central office 2008.

Turning now to FIG. 3, a block diagram of a telephony device or handset according to an embodiment of the present invention is shown. The telephony handset 100 includes a controller or control processor 202 which may be implemented as one or more processors or controllers and a memory 210. In the case of a cellular telephone, for example, such control circuitry is provided to control, among other things, the switching of a telephone call between cells. In addition, telephony handset 100 includes a transceiver and modulator unit 208 coupled to the control processor 202. A DTMF control or decoder may also be coupled to the controller 202. The display 116, voice activation access key 106, keypad 112, microphone 110, and speaker 108 are also operably coupled to control processor 202.

The controller 202 may implement a voice recognition unit 204 and a number generator 205 according to embodiments of the present invention. As will be explained in greater detail below, the voice recognition unit 204 is coupled to receive voice data, such as an address book entry, and store it in memory 210 as its constituent voice elements in association with a corresponding telephone number. When the address book is accessed, by activating the access key 106, and a name is spoken, the voice recognition unit 204 will extract parameters from the input voice and compare the input voice to the stored pattern or template 213. The speech templates 213 may be any of a variety of speech templates. A measure of similarity, such as least squares, may be used to determine whether the extracted parameters correspond to the store pattern. A match typically occurs if the measure is less than a predetermined value. If there is a match, the address book 211 will be accessed for the appropriate number. The number generator 205 will then generate the appropriate number from memory 210 and play or read the number on the speech channel using voice synthesis techniques.

It is noted that, while a block diagram of a particular handset has been shown, other configurations are possible. Thus, the figure is exemplary only. It is further noted that other embodiments may not employ the voice activation access key 106. In such embodiments, either the address book 211 may be activated through a special voice command or through conventional soft key(s). The address book 211 may be accessed then, again through a voice command as described above, or through conventional “scrolling” using one or more soft keys. Once the desired entry has been selected, the corresponding numbers may be vocalized, as discussed above.

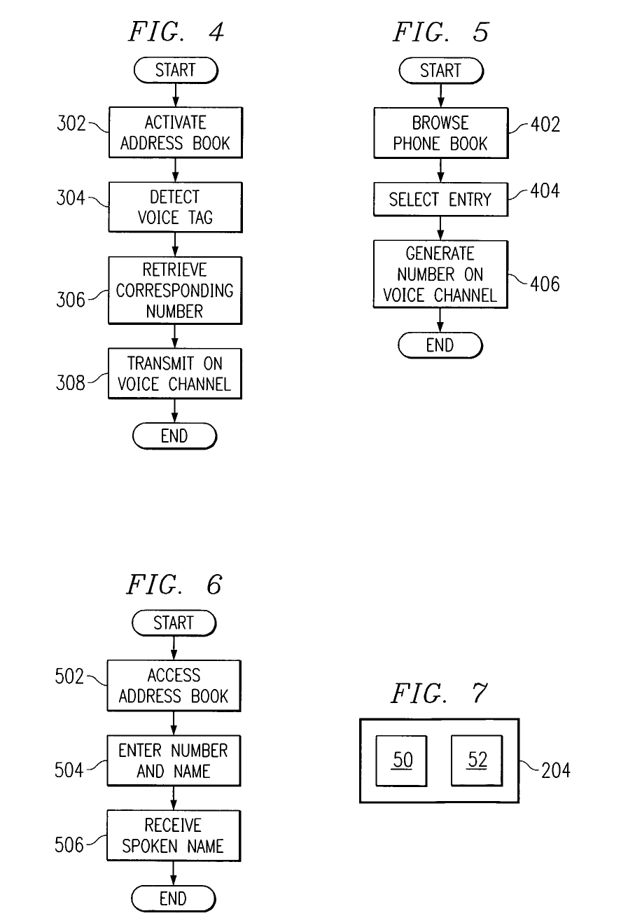

Turning now to FIG. 4, a flowchart illustrating operation of an embodiment of the present invention is shown. Initially, at step 302, the address book 211 is accessed during a telephone conversation. As noted above, this may occur in response to a party to a call asking for a third party's telephone number. Also as discussed above, accessing the address book 211 according to embodiments of the present invention typically occurs via activating the voice activation access key 106. In response, the telephony handset 100 will activate the voice recognition unit to be ready to receive commands, i.e., the desired address book entry or voice tag. When the user speaks the voice tag, in step 304, the voice recognition unit 204 receives the voice tag, and compares it to the table of voice templates 213 in memory 210. For example, the voice recognition unit 214 may break the input speech break it into constituent elements for the comparison. As noted above, a match may occur if the input speech is within a predetermined similarity threshold to the speech template. In step 306, if there is a match, the corresponding telephone number or address book entry is retrieved. The voice tag entry may be played back from the speech template for confirmation. In step 308, the address book entry, e.g., telephone number is played or transmitted to the asking party over the speech channel by accessing the number generator 205.

Turning now to FIG. 5, a flowchart illustrating a method according to another embodiment of the present invention is shown. In particular, FIG. 5 illustrates accessing the address book and transmitting the entry in a telephony handset that does not have an access key. In response, for example, to a request for a third party telephone number, a user can browse the address book in a conventional manner, in step 402. For example, this can include the using the soft keys and display 116. In step 404, the user can select an entry from the address book. For example, the user can highlight and select an entry on the display. In step 406, the number generator 205 transmits the number over the speech channel to the requester.

Turning now to FIG. 6, a flowchart illustrating a method according to another embodiment of the present invention is shown. In particular, FIG. 6 illustrates a method for making (or accepting from other senders) address book entries. In a step 502, the user accesses the address book. This can be done, for example, through use of the soft keys 114 and display 116. In step 504, the user can manually enter the desired name and number into the address book, for example, using the alphanumeric keypad 112. In step 506, the telephony handset may prompt the user to speak a voice tag, which is then analyzed and stored as voice templates. In an alternative embodiment, the receiving user in step 504 can automatically enter the desired name and number transmitted by a sender to the receiving user in the voice channel by activating the receiving device's address book to accept the new entry, or by saving the received voice channel information containing the new entry in the device's memory (e.g., for devices having a voice memo or recording feature) for later manual entry into the device's address book.

A particular voice recognition unit 204 is illustrated in FIG. 7. The voice recognition unit 204 is coupled to receive encoded voice data; for example, linear predictive coding filter coefficients and/or excitation encoding indices such as provided by a VSELP (vector sum excited linear prediction) coder. In a VSELP coder, the filter coefficients are representative of, for example, the resonant peaks or formants of the input speech. Other types of coding may be employed.

The voice recognition unit 204 includes a frequency response and peak detector circuit 50 configured to detect the peak values of vocal frequencies. A formant extraction unit 52 is coupled to the output of the peak detector 50 to extract the formants of the characterized speech. The formants are applied by the control unit 50 to search a phoneme database (e.g., templates) in storage unit 210, which includes information in database form which correlates formants to phonemes.

While a particular voice recognition module has been described above, the voice recognition unit 204 may be any of a variety of known voice recognition modules, such as phoneme based voice recognition systems, with a capability to introduce new words and make them available “on the fly.” In such systems, phoneme pre-processing of a sufficiently large vocabulary of lexicon may be employed, either via voice or text input. For example, the voice recognition unit 204 may use systems such as those described in Hunt et al., U.S. Pat. No. 5,499,288, assigned to Voice Control Systems, Inc., or the system described in Vollert, U.S. Pat. No. 5,166,971, assigned to Siemens AG, and which are hereby incorporated by reference in their entirety as if fully set forth herein.

The invention described in the above detailed description is not intended to be limited to the specific form set forth herein, but is intended to cover such alternatives, modifications and equivalents as can reasonably be included within the spirit and scope of the appended claims.

What is claimed is:

1. A telecommunications device, comprising:
a memory for storing one or more digits;
voice control means for accessing said one or more digits; and
means for transmitting said one or more digits responsive to said voice control means.

2. A telecommunications device in accordance with claim 1, further comprising:
a housing; and
a control device set in said housing for activating said voice control means

3. A telecommunications device in accordance with claim 1, said transmitting means comprising means for transmitting said digits as audio signal.

4. A telecommunications device in accordance with claim 2, said control device comprising an activation button.

5. A telecommunications device in accordance with claim 1, said memory comprising an address book memory.

6. A telecommunications method, comprising:
establishing a connection between a plurality of telephony devices;
retrieving one or more stored digits at one of said telephony devices; and
transmitting the one or more stored digits to another of said plurality of telephony devices.

7. A method in accordance with claim 6, said retrieving comprising retrieving with one or more voice tags.

8. A method in accordance with claim 6, said transmitting comprising playing said one or more stored digits as an audio signal.

9. A telecommunications handset, comprising:
a housing including a speaker and a microphone and having a face;
a keypad positioned on said face;
a memory operably coupled within said housing, said memory adapted to store an address book of phone numbers;
a controller operably coupled within said housing, said controller adapted to transmit one or more of said phone numbers responsive to said voice command to a connected party.

10. A telecommunications handset in accordance with claim 9, said controller being adapted to transmit said phone numbers as one or more audio signals.

11. A telecommunications handset in accordance with claim 9, said controller being adapted to transmit said phone numbers as tone signals.

12. A telecommunications handset in accordance with claim 9, said controller adapted to access said address book via voice command.

13. A telecommunications handset in accordance with claim 9, said controller being adapted to access a voice control functionality via a function key on a face of said housing different from said keypad face.

14. A telecommunications system, comprising:
one or more telecommunications devices, the telecommunications devices comprising a housing including a speaker and a microphone and having a face;
a keypad positioned on said face;
a memory adapted to store an address book of phone numbers; and
a controller adapted to transmit one or more of said phone numbers responsive to said voice command to a connected party.

15. A telecommunications system in accordance with claim 14, said controller being adapted to transmit said phone numbers as one or more audio signals.

16 A telecommunications system in accordance with claim 15, said controller adapted to access said address book via voice command.

17. A telecommunications system in accordance with claim 15, said controller being adapted to access a voice control functionality via a function key on a face of said device different from said keypad face.
